(19) United States
(12) Patent Application Publication
(10) Pub. No.: US 2011/0190431 A1
(43) Pub. Date: Aug. 4, 2011

(54) METHOD OF MINIMIZING A CATALYTIC EFFECT OF AN IRON CONTAMINANT PRESENT IN AN ISOCYANATE COMPOSITION

(76) Inventors: Thomas G. Savino, Northville, MI (US); Sandra Bananto, Dearborn, MI (US); Jason L. Gibson, Burton, MI (US)

(21) Appl. No.: 12/696,843

(22) Filed: Jan. 29, 2010

(51) Int. Cl. C08K 5/07

(52) U.S. Cl. 524/357

(57) ABSTRACT

Iron contaminants are associated with a beta-dicarbonyl in an isocyanate composition that includes polymeric methylene diphenyl diisocyanate (PMDI). The association of the iron contaminant and the beta-dicarbonyl is thought to minimize a catalytic effect of the iron contaminant when the isocyanate composition is reacted with a polyol to form a polyurethane. The iron contaminant is associated with the beta-dicarbonyl in a method that includes the step of providing the isocyanate composition and the step of combining the beta-dicarbonyl and the isocyanate composition. The isocyanate composition is included in a polyurethane system and typically includes the association product of the iron contaminant and the beta-dicarbonyl.

### FIELD OF THE INVENTION

The present invention generally relates to a method of minimizing a catalytic effect of an iron contaminant that is present in an isocyanate composition. More specifically, a beta-dicarbonyl associates with the iron contaminant and minimizes a catalytic efficiency of the iron contaminant on the formation of a polyurethane.

### DESCRIPTION OF THE RELATED ART

Methylene diphenyl diisocyanate (MDI) and polymeric MDI (PMDI) are typically manufactured in continuous processes from phosgenation reactions of aromatic amines in large scale metal reactors. Use of these metal reactors typically results in trace amounts of iron contaminants leaching into the MDI and PMDI on a parts per million (ppm) scale. As is well known in the art, iron contaminants, even in concentrations as little as 5 ppm, act both positively and negatively as potent catalysts in polyurethane forming reactions, depending on reaction requirements. In many applications, the iron contaminants significantly affect reactivity profiles of isocyanates and lead to premature formation of polyurethanes. This premature formation of polyurethanes greatly limits the commercial usefulness of isocyanates in specialized applications such as 1-component polyurethane “Foam in a Can” sealing and insulating products. In many of these applications, only isocyanates having low (<5 ppm) concentrations of iron contaminants and corresponding low reactivity profiles can be used. This minimizes the overall market for isocyanates, increases the cost of these specialized applications, and increases the waste of PMDI that cannot be otherwise utilized due to high concentrations of the iron contaminants. Accordingly, there remains an opportunity to minimize a catalytic effect of iron contaminants in isocyanates.

### SUMMARY OF THE INVENTION AND ADVANTAGES

The instant invention provides a method of minimizing a catalytic effect of an iron contaminant present in an isocyanate composition that is reacted with a polyol to form a polyurethane. The method includes the step of providing the isocyanate composition which includes polymeric methylene diphenyl diisocyanate and the iron contaminant. The method also includes the step of combining a beta-dicarbonyl and the isocyanate composition to associate the beta-dicarbonyl with the iron contaminant. The instant invention also provides an isocyanate composition that includes polymeric methylene diphenyl diisocyanate, the beta-dicarbonyl, and the iron contaminant.

The beta-dicarbonyl has two carbonyl (C═O) groups separated by a single carbon atom which typically associate with the iron contaminant thereby minimizing the catalytic efficiency of the iron contaminant. Although association of the iron contaminant and the beta-dicarbonyl does not decrease a concentration of the iron contaminant in the isocyanate composition, the addition of the beta-dicarbonyl stabilizes the reactivity profile of the isocyanate composition and reduces the catalytic effect of the iron contaminant. This allows the isocyanate composition to be utilized in many specialized applications that are traditionally limited to “low-iron” isocyanates and also extends the shelf-life of the isocyanate composition.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings wherein:

FIG. 1A is a line graph illustrating the decreased exotherm temperatures of the Polyurethanes 1-4 of this invention as compared to the Comparative Polyurethanes 1-4, as a function of time;

FIG. 1B is a line graph illustrating the decreased exotherm temperatures of the Polyurethanes 1-4 of this invention as compared to the Comparative Polyurethanes 5-10, as a function of time;

FIG. 1C is a combination of the line graphs of FIGS. 1A and 1B and illustrates the decreased exotherm temperatures of the Polyurethanes 1-4 of this invention as compared to the Comparative Polyurethanes 1-10, as a function of time; and

FIG. 2 is a line graph illustrating exotherm temperatures of the Polyurethanes 5-9 of this invention as a function of time.

### DETAILED DESCRIPTION OF THE INVENTION

The instant invention provides a method of minimizing a catalytic effect of an iron contaminant present in an isocyanate composition. The iron contaminant may originate from any source but typically originates from formation of the PMDI in metal reactors that include iron, as is described in greater detail below. In various embodiments, the iron contaminant originates from pipes, vessels, valves, reactors, distillation equipment, and the like.

The iron contaminant may be any type known in the art. The iron contaminant may include elemental iron (Fe) in a (II), (III), (IV), (V), and/or (VI) oxidation state. In one embodiment, the elemental iron has a 2+(II) oxidation state. In another embodiment, the elemental iron has a 3+ (III) oxidation state. In still other embodiments, the elemental iron has a 4+ (IV), 5+ (V), and/or 6+ (VI) oxidation state.

The iron contaminant can include a combination of elemental iron and iron complexed with other compounds, such as ligands. Alternatively, the iron contaminant may include greater than 99 wt % of iron complexes with ligands. In one embodiment, the iron contaminant is present, at least in part, as iron oxide, e.g. as hydrated iron(III) oxides Fe₂O₃.nH₂O and/or as iron(III) oxide-hydroxides (FeO(OH), Fe(OH)₃). Alternatively, the iron contaminant may be present entirely as iron oxide. In one embodiment, at least a portion of the iron contaminant is further defined as iron (III) oxide. In another embodiment, at least a portion of the iron contaminant is further defined as iron (II) oxide. It is contemplated that the iron contaminant can consist essentially of iron (III) oxide and/or iron (II) oxide. In these embodiments, the terminology “consist essentially of refers to the iron contaminant being limited to including iron (III) oxide and/or iron (II) oxide without including amounts of other metal oxides that would materially affect the basic and novel characteristics of the invention. Alternatively, the iron contaminant can consist of iron (III) oxide and/or iron (II) oxide. As is well known in the art, iron (II) and (III) oxides are typically present in one or more of the following forms: (a) FeO (i.e., iron (II) oxide, wüstite), (b) Fe₃O₄, (i.e., iron (II,III) oxide, magnetite), (c) Fe₂O₃, (i.e., iron (III) oxide, hematite), α-Fe₂O₃ (i.e., hematite), β-Fe₂O₃, γ-Fe₂O₃ (i.e., maghemite), and ε-Fe₂O₃. It is also contemplated that the iron contaminant may be further defined as an iron-halogen compound such as iron chlorine (FeCl₃).

The iron contaminant may be present in any amount in the isocyanate composition. Typically, the iron contaminant is present in an amount of at least 3 parts, and up to 20 parts, by weight per one million parts by weight of the isocyanate composition. However, the amount of iron contaminant is not particularly limited. In various embodiments, the iron contaminant is present in an amount of from 5 to 20, from 3 to 15, from 5 to 15, from 3 to 13, from 5 to 13, from 3 to 10, from 5 to 10, from 8 to 12, from 8 to 10, from 6 to 12, from 6 to 10, or from 6 to 9, parts by weight per one million parts by weight of the isocyanate composition. In other embodiments, the iron contaminant is present in amounts of less than 20, less than 10, or less than 8, parts by weight per one million parts by weight of the isocyanate composition. It is also contemplated that the iron contaminant can be present in any amount, or range of amounts, within the aforementioned ranges. Typically, the amount of the iron contaminant present is determined using a spectroscopic method such as atomic absorption spectroscopy or inductively coupled plasma atomic emission spectroscopy.

Typically, iron contaminants, in concentrations of as little as 5 ppm, act as potent catalysts in polyurethane forming reactions of isocyanates and polyols/amines. Accordingly, the method also includes the step of combining a beta-dicarbonyl and the isocyanate composition to associate the beta-dicarbonyl with the iron contaminant which typically minimizes the catalytic effect of the iron contaminant when the isocyanate composition is reacted with a polyol or resin composition. It is to be understood that the isocyanate composition may include less than 5, but greater than 0, ppm of the iron contaminant so long as the iron contaminant is present in some amount.

The terminology “associate,” in the context of the beta-dicarbonyl “associating” with the iron contaminant, can include the formation of a dative bond (also known as a coordinate covalent bond, a dipolar bond, a coordinate link, or a semi-polar bond) between the iron contaminant and the beta-dicarbonyl in a typical metal-ligand chelating relationship. Typically, dative bonds form when a Lewis base (e.g. the beta-dicarbonyl) donates a pair of electrons to a Lewis acid (e.g. the iron contaminant) to form an adduct. Without intending to be bound by any particular theory, it is hypothesized that the beta-dicarbonyl may acquire a positive formal charge from donating electrons while the iron contaminant can acquire a negative formal charge from accepting the donated electrons. Alternatively, the beta-dicarbonyl may associate with the iron contaminant through formation of hydrogen bonds, through formation of an ionic bond, and/or through physical interactions such as dipole-dipole interactions and/or van der Waals forces. It is also contemplated that more than one of the aforementioned associations can occur simultaneously. Typically, the beta-dicarbonyl associates with the iron contaminant at room temperature and at atmospheric pressure. However, the temperature and/or the pressure can be increased or decreased as desired by one of skill in the art and are not particularly limited in this invention.

Referring back to the beta-dicarbonyl, the beta-dicarbonyl may be any known in the art. As is well recognized in the art, beta-dicarbonyls have two carbonyl (C═O) bonds separated by a single carbon atom. Typically, the beta-dicarbonyl includes carbonyl bonds at (1) and (3) positions, as defined in IUPAC nomenclature of organic chemistry. In these embodiments, the beta-dicarbonyl may be further defined as a 1,3-diketone. However, it is also contemplated that the beta-dicarbonyl may be further defined as one or more compounds that simply have two carbonyl (C═O) bonds separated by a single carbon atom and thus remain in a 1,3-type structure but do not have the carbonyl bonds at the traditionally defined IUPAC (1) and (3) positions. In other words, the one or more compounds can have the two carbonyl (C═O) bonds within a larger molecule such that the carbonyl bonds are not at the traditionally defined IUPAC (1) and (3) positions yet remain separated by a single carbon atom. Without intending to be bound by any particular theory, it is believed that the conformation of two carbonyl bonds separated by a single carbon atom, notwithstanding location at the traditional (1) and (3) positions, allows for the most efficient association with the iron contaminant. It is also believed that this conformation is kinetically and thermodynamically favorable for complexation of the iron contaminant and the beta-dicarbonyl. In other words, it is believed that this conformation provides for a more complete association or complexation with the iron contaminant as compared to other di-ketones.

The beta-dicarbonyl can be in ionic or anionic form, in an uncharged form, or in a combination of forms. In one embodiment, the beta-dicarbonyl is in an anionic form and complexes with the iron contaminant wherein oxygen atoms of the 1,3-diketone bond to the iron contaminant to form chiral six-membered chelated rings in octahedral, i.e., orthogonal or trigonal prismatic, conformations, as further described below.

The beta-dicarbonyl typically has the following structure:

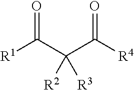

wherein each of R¹ and R⁴ is independently selected from the group of a C₁-C₁₀ alkyl group, a C₁-C₁₀ alkenyl group, an aromatic group including, but not limited to, a phenyl group and a benzyl group, halogenated derivates thereof, oxygenated derivatives thereof, and combinations thereof. R¹ and R⁴ are typically C₁-C₁₀ alkyl groups and may or may not be identical. Typically, R² and R³ are hydrogen atoms. However, each of R² and R³ may be the same or different from one or both of R¹ and R⁴.

In one embodiment, the beta-dicarbonyl is further defined as 2,4-pentanedione, also known in the art as acetylacetonate (AcAc), acetylacetone, and 2,4-pentanedionate. For descriptive purposes only, the structure of 2,4-pentanedione is set forth below:

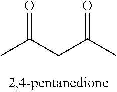

As is also known in the art, keto and enol forms of 2,4-pentanedione coexist in solution as tautomers wherein the enol is a vinylogous analogue of a carboxylic acid. For descriptive purposes only, the structure of the enol is set forth below:

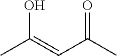

Accordingly, the beta-dicarbonyl can be further defined as a mixture of keto and enol tautomers of 2,4-pentanedione in solution as depicted below:

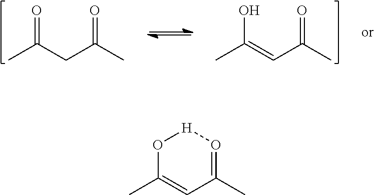

Moreover, one or both of the keto and enol tautomers can be present in an anionic form and associate with, or complex with, the iron contaminant. It is contemplated that the iron contaminant may include elemental iron such that elemental iron and the 2,4-pentanedione complex to form Fe(AcAc)₂ and/or Fe(AcAc)₃. For descriptive purposes only, a chiral chemical structure of Fe(AcAc)₃ is set forth below:

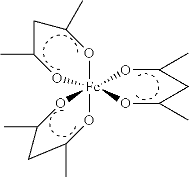

Alternatively, the beta-dicarbonyl can include one or more of the following alone, in combination with each other, in combination with 2,4-pentanedione, or in combination with each other and with 2,4-pentanedione simultaneously:

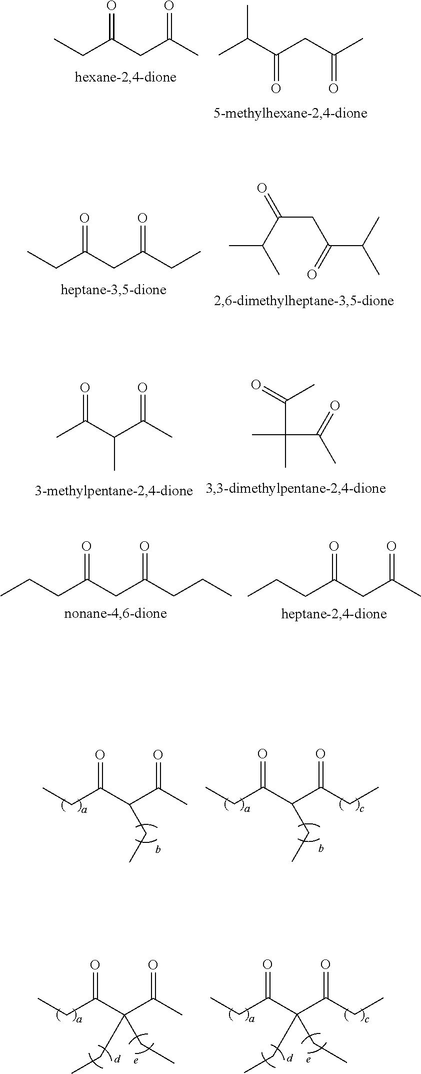

In various embodiments, one or more of (a), (b), (c), (d) and (e) of the above chemical structures is independently a number of from 1 to 10. In another embodiment, the beta-dicarbonyl is further defined as 3-chloro-2,4-pentanedione.

In various embodiments, an amount of beta-ketoesters is reduced or eliminated in the isocyanate composition. As is known in art, beta-ketoesters typically have one of the chemical structures shown below:

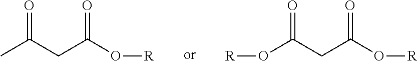

wherein R is a carbon-containing group. Without intending to be limited by any particular theory, it is believed that beta-ketoesters are not as efficient as beta-dicarbonyls in minimizing the catalytic effect of the iron contaminant because an enol form may not be as favored in beta-ketoesters. Accordingly, in one embodiment, the isocyanate composition is free of beta-ketoesters. In another embodiment, the isocyanate composition is substantially free of beta-ketoesters. In this context, the terminology “substantially free” refers to an amount of beta-ketoesters of less than 1, more typically less than 0.1, and most typically less than 0.1, wt %, in the isocyanate composition.

In other embodiments, the isocyanate composition is free of, or substantially free of, phosphoric acid esters and/or acid generators. Phosphoric acid esters and acid generators are also believed to be less efficient than the beta-dicarbonyl of this invention and are preferably minimized in the instant invention. In this context, the terminology “substantially free” refers to an amount of phosphoric acid esters and/or acid generators of less than 1, more typically less than 0.1, and most typically less than 0.1, wt %, in the isocyanate composition.

Referring back to the method, the method includes the step of providing the isocyanate composition which includes polymeric methylene diphenyl diisocyanate (PMDI) and the iron contaminant. As is known in the art, PMDI typically includes a mixture of dimers and trimers and higher oligomers of methylene diphenyl diisocyanate (MDI). In various embodiments, the isocyanate composition includes from 10 to 100, from 20 to 100, from 30 to 100, from 40 to 100, from 50 to 100, from 60 to 100, from 70 to 100, from 80 to 100, from 90 to 100, or from 95 to 100, parts by weight of the PMDI per 100 parts by weight of the isocyanate composition. In other embodiments, the isocyanate composition includes from 50 to 90, from 50 to 80, from 50 to 70, from 50 to 60, from 60 to 90, from 60 to 80, or from 60 to 70, parts by weight of the PMDI per 100 parts by weight of the isocyanate composition. In still other embodiments, the isocyanate composition includes from 50 to 55, from 55 to 60, from 60 to 65, from 65 to 70, from 70 to 75, or from 75 to 80 parts by weight of the PMDI per 100 parts by weight of the isocyanate composition. In even further embodiments, the isocyanate composition includes from 55 to 65, from 65 to 75, or from 75 to 85 parts by weight of the PMDI per 100 parts by weight of the isocyanate composition. It is also contemplated that the PMDI may be present in the isocyanate composition in any amount, or range of amounts, within the aforementioned ranges. The isocyanate composition can consist essentially of the PMDI or may consist of the PMDI. In this context, the terminology “consisting essentially of refers to the isocyanate composition being limited to including the PMDI without amounts of one or more isocyanates that would materially affect the basic and novel characteristics of the invention. In various embodiments, the isocyanate composition is, or includes, Lupranate® M10, Lupranate® M20, Lupranate® 266, Lupranate® 230, Lupranate® 255, Lupranate® TF-2115, Lupranate® 234, Lupranate® M20SB, Lupranate® M20FB, Lupranate® M20S, Lupranate® 223, Lupranate® 5110, and Lupranate® R2500U, each of which is commercially available from BASF Corporation.

In other embodiments, the isocyanate composition includes monomeric methylene diphenyl diisocyanate (MDI) in 2,2-, 2,4-, and/or 4,4′ conformations. In various embodiments, the monomeric MDI is present in amounts of from 10 to 50, from 20 to 50, from 30 to 50, from 40 to 50, from 10 to 40, from 20 to 40, or from 30 to 40, parts by weight per 100 parts by weight of the isocyanate composition. In still other embodiments, the MDI is present in amounts of from 45 to 50, from 40 to 45, from 35 to 40, from 30 to 35, from 25 to 30, or from 20 to 25 parts by weight per 100 parts by weight of the isocyanate composition. In further embodiments, the MDI is present in amounts of from 35 to 45, from 25 to 35, or from 15 to 25, parts by weight per 100 parts by weight of the isocyanate composition. It is also contemplated that the isocyanate composition may include MDI in an amount such that: (the amount of PMDI)+(the amount of MDI) is approximately equal to 100 wt % of the isocyanate composition. In other words, the MDI and PMDI, together, may constitute all or almost all of the isocyanate composition. It further contemplated that the monomeric MDI can be present in the isocyanate composition in any amounts, or any range of amounts, within the above ranges, as determined by one of skill in the art. Typically, iron contaminants are not present in MDI because MDI is traditionally separated from PMDI via distillation which leaves a majority of the iron contaminants present in the PMDI “bottoms” product. However, the instant invention is not limited in this way.

The isocyanate composition may also include one or more additional isocyanates. The one or more additional isocyanates are not particularly limited and can be any known in the art. In various embodiments, the one or more additional isocyanates include an aromatic isocyanate, an aliphatic isocyanate, and/or combinations thereof. The aromatic isocyanate typically corresponds to the formula R′(NCO)_{z} wherein R′ is a polyvalent organic radical which is aromatic and z is an integer that corresponds to the valence of R′. Typically, z is at least two.

The one or more additional isocyanates may include, but are not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, polymethylene polyphenylene polyisocyanate, corresponding isomeric mixtures thereof, and combinations thereof.

The one or more additional isocyanates can also include a modified multivalent aromatic isocyanate, i.e., a product which is obtained through chemical reactions of aromatic diisocyanates and/or aromatic polyisocyanates. Examples include polyisocyanates including, but not limited to, ureas, biurets, allophanates, carbodiimides, uretonimines, and isocyanurate and/or urethane groups including diisocyanates and/or polyisocyanates such as modified diphenylmethane diisocyanates. The one or more additional isocyanates may also include, but is not limited to, modified benzene and toluene diisocyanates, employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

The one or more additional isocyanates can have any % NCO content known in the art but typically have a % NCO of from 8 to 48 percent by weight as determined using a standard chemical titration analysis known to those skilled in the art. Also, the one or more additional isocyanates may have any nominal functionality but typically have a nominal functionality of from 1.7 to 3. Further, the one or more additional isocyanates can have any number average molecular weight but typically have a number average molecular weight of from 125 to 525 g/mol. Still further, the one or more additional isocyanates typically may have any viscosity but typically have a viscosity of from 15 to 2000 cps at 25° C. In various embodiments, the isocyanate composition includes polymethylene polyphenyl isocyanate (PMPPI) (CAS #57029-46-6), polymethylenepolyphenyl polyisocyanate, polypropyleneglycol, copolymer (CAS #53862-89-8), Polymethylenepolyphenyl polyisocyanate (CAS #9016-87-9), 4,4′-methylenediphenyl diisocyanate (CAS #101-68-8), and/or combinations thereof.

The step of providing the isocyanate composition can be further defined as acquiring the isocyanate composition for use in this invention. Alternatively, the step of providing may be further defined as disposing the isocyanate composition in a reactor or storage vessel. In addition to the step of providing the isocyanate composition, the method also includes the step of combining the beta-dicarbonyl and the isocyanate composition such that the beta-dicarbonyl associates with the iron contaminant in the isocyanate composition. The step of combining can be further defined as mixing, stirring, vortexing, blending, or any other step of combining known in the art. In one embodiment, the beta-dicarbonyl is added to the isocyanate composition, i.e., a content of the beta-dicarbonyl is added to the isocyanate composition. Alternatively, the isocyanate composition may be added to the beta-dicarbonyl. In a further embodiment, a first mixture of the beta-dicarbonyl and the isocyanate composition is added to a second mixture of the beta-dicarbonyl and the isocyanate composition. Typically, an amount of the beta-dicarbonyl is combined with the isocyanate composition in a reactor or storage vessel. Most typically, the beta-dicarbonyl is liquid and is poured into the isocyanate composition in the reactor or storage vessel and mixed therein. The step of combining can occur at any point in the method.

The beta-dicarbonyl can be combined with the isocyanate composition in any amount. Typically, the beta-dicarbonyl is combined with the isocyanate composition in an amount of from 100 to 200 parts by weight of the beta-dicarbonyl per one million parts by weight of the isocyanate composition. In various embodiments, the beta-dicarbonyl is combined with the isocyanate composition in amounts of approximately 100, 125, 175, or 200 parts by weight of the beta-dicarbonyl per one million parts by weight of the polymeric methylene diphenyl diisocyanate. In other embodiments, the beta-dicarbonyl is combined with the isocyanate composition in amounts of approximately 138, 159, and 176 parts by weight of the beta-dicarbonyl per one million parts by weight of the isocyanate composition. In still other embodiments, the beta-dicarbonyl is combined with the isocyanate composition in amounts of from 100 to 175, from 125 to 200, from 125 to 150, from 125 to 175, from 150 to 175, from 150 to 200, or from 175 to 200, parts by weight of the beta-dicarbonyl per one million parts by weight of the isocyanate composition. In even further embodiments, the beta-dicarbonyl is combined with the isocyanate composition in amounts of greater than 200, greater than 300, greater than 400 or greater than 500 parts by weight of the beta-dicarbonyl per by weight per one million parts by weight of the isocyanate composition. It is also contemplated that the beta-dicarbonyl can be combined with the isocyanate composition in amounts of 500 to 2000, 500 to 1500, or 500 to 1000, parts by weight of the beta-dicarbonyl per by weight per one million parts by weight of the isocyanate composition. It is to be understood that the beta-dicarbonyl may be combined with the isocyanate composition in any amount, or in any range of amounts, in between the aforementioned ranges, as selected by one of skill in the art.

In one embodiment, the iron contaminant is present in an amount of up to 20 parts by weight per one million parts by weight of the isocyanate composition and the beta-dicarbonyl is introduced in an amount of from 100 to 200 parts by weight per one million parts by weight of the isocyanate composition. In another embodiment, the iron contaminant is present in an amount of up to 20 parts by weight per one million parts by weight of the isocyanate composition and the beta-dicarbonyl is introduced in an amount of at least 100 parts by weight per one million parts by weight of the isocyanate composition. In still another embodiment, the iron contaminant is present in an amount of up to 20 parts by weight per one million parts by weight of the isocyanate composition and the beta-dicarbonyl is introduced in a ratio of at least 100:1 by weight of the beta-dicarbonyl to the iron. Typically, the step of combining the beta-dicarbonyl and the isocyanate composition results in the isocyanate composition having less than 3 parts by weight of non-associated iron (III) oxide per one million parts by weight of the isocyanate composition. In various embodiments, the isocyanate composition includes less than 10, 7, 5, 3, or 1 part by weight of non-associated iron (III) oxide per one million parts by weight of the isocyanate composition subsequent to the step of combining the beta-dicarbonyl and the isocyanate composition.

In another embodiment, the isocyanate composition further comprises monomeric methylene diphenyl diisocyanate in an amount of from 25 to 90 parts by weight per 100 parts by weight of the isocyanate composition and the beta-dicarbonyl is further defined as 2,4-pentanedione. In an alternative embodiment, the isocyanate composition further comprises monomeric methylene diphenyl diisocyanate in an amount of from 25 to 50 parts by weight per 100 parts by weight of the isocyanate composition and the beta-dicarbonyl is further defined as 2,4-pentanedione. In yet another embodiment, the isocyanate composition further comprises monomeric methylene diphenyl diisocyanate in an amount of from 55 to 60 parts by weight of the isocyanate composition and the beta-dicarbonyl is further defined as 2,4-pentanedione. It is also contemplated that the isocyanate composition can further comprise monomeric methylene diphenyl diisocyanate in an amount of from 65 to 70 parts by weight of the isocyanate composition and the beta-dicarbonyl may be further defined as 2,4-pentanedione. In still another embodiment, the isocyanate composition further comprises monomeric methylene diphenyl diisocyanate in an amount of from 75 to 80 parts by weight of the isocyanate composition and the beta-dicarbonyl is further defined as 2,4-pentanedione.

In addition to the steps described above, the method may also include the step of forming the PMDI. In one embodiment, the method includes the step of forming the PMDI in a reactor such that the PMDI includes the iron contaminant. As is known in the art, the PMDI is typically formed via a two-step process beginning with a condensation reaction between aniline and formaldehyde that yields diphenylmethane diamine. A subsequent phosgenation reaction typically forms the methylene diphenyl diisocyanate as a mixture of monomeric MDI and higher functional oligomers of MDI including trifunctional, tetrafunctional, and higher functional oligomers of MDI (collectively known in the art as “crude MDI”.) Then, typically a portion of the monomeric MDI is removed from the crude MDI via distillation or fractionation, which typically leaves a concentration of the iron contaminant in the bottoms product which includes the PMDI. Of course, the instant invention is not limited to the aforementioned formation and purification steps and can include any formation and purification steps known in the art for the production of PMDI.

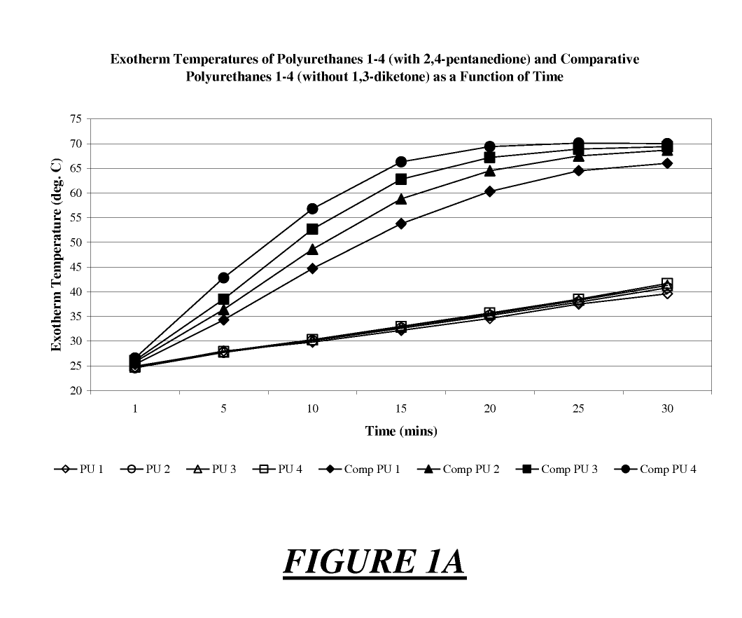

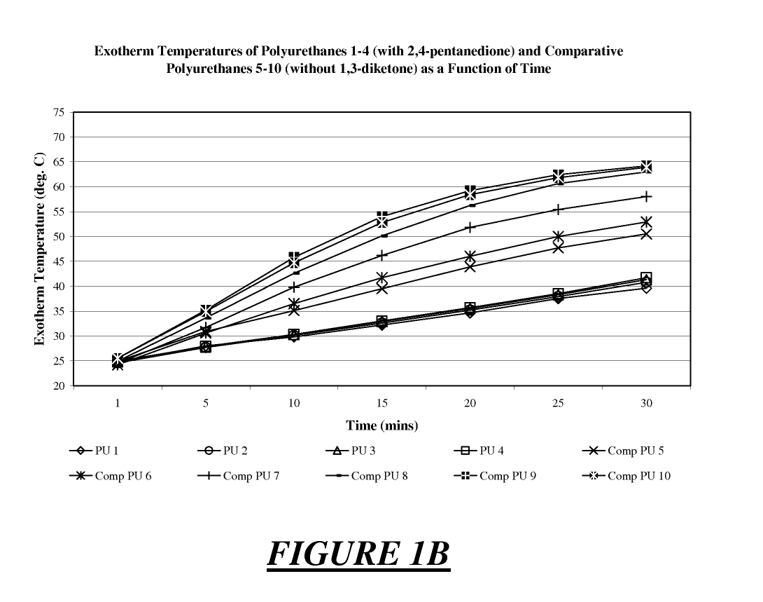

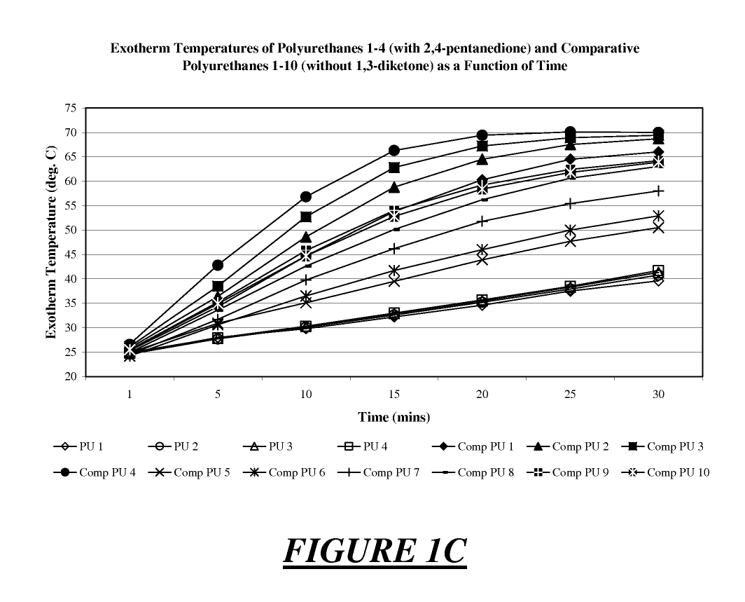

The method of this invention can also include the step of reacting the isocyanate composition and the polyol to form a prepolymer and/or a polyurethane. Typically, the step of reacting occurs after the step of combining the beta-carbonyl and the isocyanate composition. Said differently, the step of combining the beta-dicarbonyl and the isocyanate composition occurs before the isocyanate composition is reacted with the polyol to form the prepolymer and/or the polyurethane. The beta-dicarbonyl typically moderates reactivity of the isocyanate composition with the polyol which results in a lower exotherm temperature than otherwise expected or predicted. In one embodiment, the step of reacting produces an exotherm temperature of less than about 45° C. measured approximately 30 minutes after the step of reacting commences, as shown in FIGS. 1A-1C. In another embodiment, the step of reacting produces an exotherm temperature of less than about 90° C. measured approximately 20 minutes after the step of reacting commences. In still other embodiments, the step of reacting produces one or more exotherms as set forth in FIGS. 1A-1C. Without intending to be bound by any particular theory, it is believed that the low exotherms are indicative of a decreased, or minimized, catalytic effect of the iron contaminant on the reactions of isocyanates and the polyols to form polyurethanes. Of course, it is to be understood that the terminology “less than about 45° C.” and “less than about 90° C.” can include 45° C. and 90° C., respectively,

The polyol that is reacted with the isocyanate composition can be any known in the art. Typically, the polyol is selected from the group of polyetherols, polyesterols, and combinations thereof. However, it is also contemplated that an amine can replace the polyol or can be used in addition to the polyol. In one embodiment, the polyol is further defined as a polyetherol. In another embodiment, the polyol is further defined as a mixture of more than one polyetherol. Alternatively, mixtures of polyesterols and/or of polyetherols and polyesterols can be utilized. The polyol may alternatively include an addition polymer dispersed within the polyol. More specifically, the polyol may include a dispersion or a solution of addition or condensation polymers, i.e., the polyol may be a graft polyol. The dispersion can include styrene, acrylonitrile, and combinations thereof. The polyol can also include an emulsion that includes water or any other polar compound known in the art.

In one embodiment, the polyol includes the reaction product of an initiator and an alkylene oxide. Typically, the initiator is selected from the group of aliphatic initiators, aromatic initiators, and combinations thereof. More typically, the initiator is selected from the group of ethylene glycol, propylene glycol, dipropylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, 1,2,6-hexanetriol, α-methyl glucoside, pentaerythritol, sorbitol, aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, triisopropanolamine, ethylenediamine, 1,3-diaminopropane, 1,3-diaminobutane, 1,4-diaminobutane, and combinations thereof. It is contemplated that any suitable initiator known in the art may be used in the present invention.

Typically, the alkylene oxide that reacts with the initiator to form the polyol is selected from the group of ethylene oxide, propylene oxide, butylene oxide, amylene oxide, tetrahydrofuran, alkylene oxide-tetrahydrofuran mixtures, epihalohydrins, aralkylene oxides, and combinations thereof. More typically, the alkylene oxide is selected from the group of ethylene oxide, propylene oxide, and combinations thereof. Most typically, the alkylene oxide includes ethylene oxide. However, it is also contemplated that any suitable alkylene oxide that is known in the art can be used in the present invention.

The polyol may include an alkylene oxide (e.g. an ethylene oxide) cap of from 1 to 20% by weight based on the total weight of the polyol. It is to be understood that the terminology “cap” refers to a terminal portion of the polyol. The polyol also typically has a number average molecular weight of from 100 to 10,000 g/mol and a hydroxyl number of from 10 to 200 mg KOH/g. The polyol also typically has a nominal functionality of from 1 to 8. The polyol also typically has a viscosity from 20 to 50,000 centipoise measured at 77° F.

The polyol that is reacted with the isocyanate composition is typically present in a resin composition. The resin composition can include a second polyol that is different from the polyol described above. The second polyol may be any known in the art. Alternatively, the resin composition may include an amine. If the compound includes the amine, the amine can be any type known in the art. The amine may include, but is not limited to, primary and secondary aliphatic and/or cyclic aliphatic amines. The amine can include any additional functional group known in the art including, but not limited to, hydroxyl groups, thiol groups, alkyl groups, cyclic groups, aromatic groups, and combinations thereof. It is to be understood that the amine may also include an amide. If the amine includes the amide, the amide can be any type known in the art. Typically the amide includes, but is not limited to, polyester amides obtained from polybasic unsaturated or saturated carboxylic acids or anhydrides, polyfunctional unsaturated or saturated amino-alcohols, and combinations thereof.

The resin composition may also include one or more additives (e.g. a plurality of additives) selected from the group of silicones, polymerization catalysts, gelling catalysts, blowing agents, surfactants, cross-linkers, inert diluents, chain extenders, anti-foaming agents, chain terminators, air releasing agents, wetting agents, surface modifiers, waxes, inert inorganic fillers, molecular sieves, reactive inorganic fillers, chopped glass, other types of glass such as glass mat, processing additives, surface-active agents, adhesion promoters, anti-oxidants, dyes, pigments, ultraviolet light stabilizers, thixotropic agents, anti-aging agents, lubricants, coupling agents, solvents, rheology promoters, and combinations thereof. The resin composition, like the isocyanate composition, can be free of, or substantially free of, beta-ketoesters, phosphoric acid esters and/or acid generators, as defined above.

In addition to the method described above, the instant invention also provides the isocyanate composition itself and a polyurethane system for use in forming a polyurethane article. In one embodiment, the isocyanate composition includes the PMDI, the beta-dicarbonyl, and the iron contaminant. Typically, the beta-dicarbonyl and the iron contaminant associate with each other when in contact with each other in the isocyanate composition. Thus, in one embodiment, the isocyanate composition includes the PMDI and the association product of the beta-dicarbonyl and the iron contaminant. The isocyanate composition may also consist of or consist essentially of the PMDI, the beta-dicarbonyl, and the iron contaminant. Alternatively, the isocyanate composition may consist of or consist essentially of the PMDI and the association product of the beta-dicarbonyl and the iron contaminant. In still other embodiments, the isocyanate composition consists of or consists essentially of the PMDI, the association product of the beta-dicarbonyl and the iron contaminant, and free (i.e., non-associated) beta-dicarbonyl. Typically, free (non-associated) beta-dicarbonyl is present if the beta-dicarbonyl is present in a molar and/or weight excess to the iron contaminant. In the embodiments wherein the isocyanate composition consists essentially of certain components, the isocyanate composition typically does not include any other isocyanates that would materially affect the basic and novel characteristics of the isocyanate composition.

The polyurethane system may include the isocyanate composition, the polyol, and/or the association product of the beta-dicarbonyl and the iron contaminant and/or free (non-associated beta-dicarbonyl) and/or free (non-associated) iron contaminant. Without intending to be bound by any particular theory, it is believed that all or almost all of the iron contaminant in the polyurethane system is associated with the beta-dicarbonyl. However, there may be a weight and/or molar excess of the beta-dicarbonyl relative to the iron contaminant such that there may be non-associated beta-dicarbonyl present in the polyurethane system even when all or almost all of the iron contaminant is associated.

Typically, the iron contaminant is present in the isocyanate composition. However, it is contemplated that the iron contaminant can be present in the polyol or in both the polyol and the isocyanate composition. It is further contemplated that the iron contaminant can originate from a source other than the isocyanate composition and the polyol.

As described initially above, the iron contaminant may be present in any amount in the isocyanate composition. It is also contemplated that the iron contaminant may be present in any amount in the polyol or in both the isocyanate composition and the polyol. In one embodiment, the iron contaminant is present in an amount of at least 3 parts, and up to 20 parts, by weight per one million parts by weight of the polyol. In other embodiments, the iron contaminant is present in an amount of from 5 to 20, from 3 to 15, from 5 to 15, from 3 to 13, from 5 to 13, from 3 to 10, from 5 to 10, from 8 to 12, from 8 to 10, from 6 to 10, or from 6 to 9, parts by weight per one million parts by weight of the polyol. It is also contemplated that the iron contaminant can be present in any amount, or range of amounts, within the aforementioned ranges. Accordingly, the association product of the beta-dicarbonyl and the iron contaminant can be present in the isocyanate composition, the polyol, or both the isocyanate composition and the polyol. Most typically, the isocyanate composition includes the PMDI and at least 3 parts by weight of the iron contaminant per one million parts by weight of the isocyanate composition.

The instant invention also provides a polyurethane formed from the polyurethane system and/or from the method of this invention. In one embodiment, the polyurethane has an exotherm temperature of less than about 45° C. measured 30 minutes after the step of reacting commences. In another embodiment, the polyurethane has an exotherm temperature of less than about 90° C. measured 20 minutes after the step of reacting commences. In still other embodiments, the polyurethane can have any exotherm temperature or range of exotherm temperatures set forth in the Figures or in the Examples described below. Without intending to be limited by any particular theory, it is believed that the intensity of the exotherm temperature is indicative of a speed of reaction of the isocyanate composition and the polyol. Said differently, higher exotherm temperatures indicate increased rates of reaction between the isocyanate composition and the polyol. Similarly, lower exotherm temperatures indicate decreased rates of between the isocyanate composition and the polyol. Moreover, decreased exotherm temperatures indicate decreased catalysis (i.e., minimized catalytic effect of the iron contaminant) in the reaction between the isocyanate composition and the polyol. Accordingly, in many embodiments, the exotherm temperatures of the polyurethanes of this invention indicate minimized catalytic effect of the iron contaminant on the reaction between the isocyanate composition and the polyol.

Typically, the method used to measure exotherm temperature includes placing a mixture of the isocyanate composition and the polyol into a foam block insulator, inserting a thermocouple into the mixture, allowing the mixture to react, and measuring a temperature of the reacting mixture. However, the invention and the determination of exotherm temperature are not limited to this method and may include any suitable method known in the art.

The polyurethane of this invention is not limited in type and can be an elastomer or a foam and may be rigid, semi-rigid, or flexible. In various embodiments, the polyurethane is formed from a 1-component system wherein the isocyanate composition and the polyol are mixed prior to use. Typically, such 1-component systems form polyurethanes upon spraying. Particularly suitable examples of such 1-component systems include polyurethane foams used in commercial and residential construction and renovation applications that are formed from spraying the isocyanate composition and the polyol from cans or cylinders. Alternatively, the polyurethane can be formed from a 2- or more component system wherein the isocyanate composition and the polyol are not mixed prior to use. In these systems, the isocyanate composition and the polyol may be stored adjacent to each other in one vessel or can be stored in independent vessels. Particularly suitable examples of the 2- or more component systems also include polyurethane foams used in commercial and residential construction and renovation applications that that are formed from spraying the isocyanate composition and the polyol. In one embodiment, the polyurethane is formed from a “foam in a can” system. In various other embodiments, the polyurethane is a foam that cures by reaction with moisture in the air and that has a density of from 1 to 2, from 1.1 to 1.8, from 1.2 to 1.6, from 1.3 to 1.6, from 1.3 to 1.35, or from 1.5 to 1.55, lbs/ft³.

### EXAMPLES

A series of isocyanate compositions (Compositions 1-17) are formed according to the instant invention and include varying amounts of an iron contaminant. A series of comparative isocyanate composition (Comparative Composition 1-23) are also formed but not according to this invention. Comparative Compositions 1-23 also include varying amounts of the iron contaminant but do not include any of the beta-dicarbonyl of this invention. During formation, corresponding Polyurethanes 1-17 and Comparative Polyurethanes 1-23 are evaluated to determine exotherm temperature.

### Formation and Evaluation of Compositions/Polyurethanes 1-4:

Compositions 1-4 include PMDI (commercially available from BASF Corporation under the trade name of Lupranate® M20) and approximately 7, 9, 11, and 13 parts by weight of iron contaminant per one million parts by weight of the PMDI, respectively. Each of these Compositions also includes approximately 200 parts by weight of 2,4-pentanedione (AcAc) per one million parts by weight of the PMDI.

The Compositions 1-4 are prepared by first combining a 1:1 solution of iron 2-ethylhexanoate (6% Fe in mineral spirits) with triethyl phosphate. The 1:1 solution of iron 2-ethylhexanoate/mineral spirits in triethylphosphate (3% Fe in solution) is subsequently heated to about 40° C. then added to unmodified PMDI in quantities such that a final iron concentration in the PMDI is about 100 ppm. Next, portions of this 100 ppm iron-containing PMDI composition are added to unmodified PMDI to afford compositions with 7, 9, 11, and 13 parts by weight of iron contaminant per million parts by weight of PMDI (i.e., Compositions 1-4, respectively).

After formation, each of the Compositions 1-4 is individually reacted with a Polyol Resin to form Polyurethanes 1-4. During formation, each of the Polyurethanes 1-4 is evaluated to determine exotherm temperature as a function of time. More specifically, 311 g of each of the Compositions 1-4 is preheated in a water bath to a temperature of approximately 25° C. and combined with 223g of the Polyol Resin, which is also pre-heated to approximately 25° C., in 600 ml plastic beakers to form mixtures. The mixtures are then stirred for 30 seconds using a motorized mixer. After 30 seconds of stirring, each of the mixtures is placed into separate foam block insulators. Subsequently, a thermocouple is placed into the center of each of the mixtures and the mixtures are covered and allowed to react to form the Polyurethanes 1-4. The thermocouples measure the exotherm temperatures of the Polyurethanes 1-4 at 1, 5, 10, 15, 20, 25, & 30 minute increments. The exotherm temperatures are set forth in Table 1 below and are depicted graphically in FIGS. 1A-1C. All temperatures set forth in Table 1 are in degrees Celsius (° C.).

### Formation and Evaluation of Comparative Compositions/Polyurethanes 1-10:

Comparative Compositions 1-4 include the same PMDI as the Compositions 1-4 and also include approximately 7, 9, 11, and 13 parts by weight of the iron contaminant per one million parts by weight of the PMDI, respectively. Comparative Compositions 5-10 include the same PMDI as the Compositions 1-4 but include approximately 3, 6, 8, 10, 12, and 14 parts by weight of iron contaminant per one million parts by weight of the PMDI, respectively. However, none of these Comparative Compositions include any 2,4-pentanedione or any beta-dicarbonyl.

After formation, each of the Comparative Compositions 1-10 is individually reacted with the Polyol Resin to form Comparative Polyurethanes 1-10 using the same method described immediately above. During formation, the Comparative Polyurethanes 1-10 are also evaluated to determine exotherm temperature as a function of time according to the method described above. The exotherm temperatures of Comparative Polyurethanes 1-10 are also set forth in Table 1 below. More specifically, the exotherm temperatures of Comparative Polyurethanes 1-4 are depicted graphically in FIGS. 1A and 1C. The exotherm temperatures of Comparative Polyurethanes 5-10 are depicted graphically in FIGS. 1B and 1C.

TABLE 1

| | Exotherm | Exotherm | Exotherm | Exotherm |
|---|---|---|---|---|
| | Temperatures | Temperatures | Temperatures | Temperatures |
| Time | (° C.) of | (° C.) of | (° C.) of | (° C.) of |
| (min) | PU 1 | PU 2 | PU 3 | PU 4 |
| 1 | 24.7 | 24.6 | 24.8 | 24.9 |
| 5 | 28 | 27.7 | 27.8 | 27.9 |
| 10 | 29.8 | 30.1 | 30.3 | 30.3 |
| 15 | 32.2 | 32.6 | 32.9 | 33 |
| 20 | 34.6 | 35.2 | 35.5 | 35.7 |
| 25 | 37.5 | 37.9 | 38.3 | 38.5 |
| 30 | 39.6 | 40.8 | 41.3 | 41.7 |

| | Exotherm | Exotherm | Exotherm | Exotherm | Exotherm |
|---|---|---|---|---|---|
| | Temperatures | Temperatures | Temperatures | Temperatures | Temperatures |
| Time | (° C.) of | (° C.) of | (° C.) of | (° C.) of | (° C.) of |
| (min) | Comp. PU 1 | Comp. PU 2 | Comp. PU 3 | Comp. PU 4 | Comp. PU 5 |
| 1 | 25.3 | 25.8 | 26.1 | 26.6 | 24.9 |
| 5 | 34.3 | 36.4 | 38.5 | 42.8 | 30.9 |
| 10 | 44.7 | 48.6 | 52.7 | 56.8 | 35.1 |
| 15 | 53.8 | 58.8 | 62.8 | 66.3 | 39.5 |
| 20 | 60.3 | 64.5 | 67.2 | 69.4 | 43.9 |
| 25 | 64.5 | 67.5 | 68.9 | 70.1 | 47.7 |
| 30 | 66 | 68.7 | 69.4 | 70 | 50.5 |
| | Exotherm | Exotherm | Exotherm | Exotherm | Exotherm |
| | Temperatures | Temperatures | Temperatures | Temperatures | Temperatures |
| Time | of (° C.) | of (° C.) | of (° C.) | of (° C.) | of (° C.) |
| (min) | Comp. PU 6 | Comp. PU 7 | Comp. PU 8 | Comp. PU 9 | Comp. PU 10 |
| 1 | 24.2 | 24.5 | 24.9 | 25.5 | 25.5 |
| 5 | 30.6 | 31.7 | 33.6 | 35.2 | 34.9 |
| 10 | 36.5 | 39.8 | 42.6 | 45.8 | 44.7 |
| 15 | 41.7 | 46.2 | 50.1 | 54 | 52.8 |
| 20 | 46 | 51.8 | 56.2 | 59.2 | 58.4 |
| 25 | 50 | 55.4 | 60.6 | 62.4 | 61.8 |
| 30 | 52.9 | 58 | 63 | 64.2 | 63.9 |

The Polyol Resin used to form the Polyurethanes 1-4 and the Comparative Polyurethanes 1-10 includes 68% Pluracol® 1203 polyol, 30% flame retardant, 1% surfactant, and 1.8% catalyst.

The iron contaminant present in the Compositions is Iron (II) ethylhexanoate.

The primary difference between the Polyurethanes 1-4 and the Comparative Polyurethanes 1-10 is the utilization of the 2,4-pentanedione to minimize the catalytic efficiency of the iron contaminant in the Compositions. Accordingly, the data set forth in Table 1, and visually depicted in FIGS. 1A-1C, suggests that the addition of the 2,4-pentanedione decreases the exotherm temperatures of the Polyurethanes 1-4 as directly compared with the Comparative Polyurethanes 1-10. As is readily recognized in the art, a decrease in exotherm temperatures corresponds to a decrease in reaction rate of the Compositions and the Polyol Resin and represents a decrease in the reactivity profile of the Compositions. Said differently, the decrease in exotherm temperature corresponds to a decrease in, and minimization of, the catalytic efficiency of the iron contaminant in the Compositions. Thus, this data suggests that the 2,4-pentanedione is effective in passivating the iron contaminant in polyurethane forming reactions and simultaneously stabilizes the reactivity profiles of the Compositions. Accordingly, the instant invention allows the Compositions to be used in a variety of specialized applications thus maximizing the overall market for PMDI, decreasing costs associated with purification and removal of the iron contaminant, and decreasing waste associated with the disposal of undesirable isocyanates.

### Formation and Evaluation of Compositions/Polyurethanes 5-9:

Each of Compositions 5-9 includes the same PMDI as the Compositions 1-4 but include approximately 13 parts by weight of the iron contaminant per one million parts by weight of the PMDI. Compositions 5-9 also include approximately 100, 138, 159, 176, and 200 parts by weight of 2,4-pentanedione (AcAc) per one million parts by weight of the PMDI, respectively.

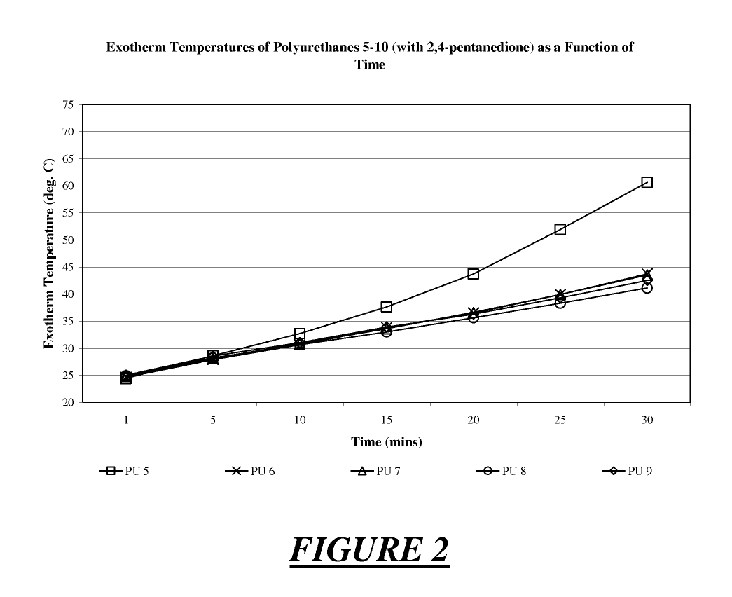

After formation, each of the Compositions 5-9 is individually reacted with the Polyol Resin to form Polyurethanes 5-9 according to the method described above. During formation, the Polyurethanes 5-9 are evaluated to determine exotherm temperature as a function of time, also according to the aforementioned method. The results of these evaluations are set forth in Table 2 below and depicted graphically in FIG. 2. All temperatures set forth in Table 2 are in degrees Celsius (° C.).

TABLE 2

| | Exotherm | Exotherm | Exotherm | Exotherm | Exotherm |
|---|---|---|---|---|---|
| | Temperatures | Temperatures | Temperatures | Temperatures | Temperatures |
| Time | (° C.) of | (° C.) of | (° C.) of | (° C.) of | (° C.) of |
| (min) | Polyurethane 5 | Polyurethane 6 | Polyurethane 7 | Polyurethane 8 | Polyurethane 9 |
| 1 | 24.4 | 24.6 | 24.8 | 24.9 | 25 |
| 5 | 28.6 | 27.9 | 28.1 | 28.2 | 28.5 |
| 10 | 32.7 | 30.6 | 30.8 | 30.6 | 31 |
| 15 | 37.6 | 33.8 | 33.6 | 33 | 33.9 |
| 20 | 43.7 | 36.5 | 36.6 | 35.6 | 36.3 |
| 25 | 51.9 | 39.9 | 39.9 | 38.3 | 39.3 |
| 30 | 60.6 | 43.7 | 43.5 | 41.1 | 42.5 |

The data set forth in Table 2, and visually depicted in FIG. 2, further suggests that the addition of the 2,4-pentanedione decreases the exotherm temperatures of polyurethanes. More specifically, the data of Table 2 demonstrates that varying amounts of the 2,4-pentanedione can be used to decrease the exotherm temperatures. As described above, the decrease in exotherm temperatures as a function of time corresponds to a decrease in reaction rate of the isocyanate composition and the polyol and represents a decrease in the reactivity profile of the isocyanate composition.

### Formation and Evaluation of Additional Compositions/Polyurethanes:

Compositions 10-15 and Comparative Compositions 11-18 are formed and reacted with a second Polyol Resin to form Polyurethanes 10-15 and Comparative Polyurethanes 11-18, respectively. A time is measured for each of the Compositions 10-15 and the Comparative Compositions 11-18 to react with the second Polyol resin and for the reaction mixture of the two to reach 90° C. Typically, a time of greater than 800 seconds indicates that the Composition is suitable for use in applications such as foam in a can products. Notably, the Comparative Compositions 11-18, and corresponding Polyurethanes, do not include any 2,4-pentanedione (AcAc).

### Formation of Compositions 10-15:

Composition 10 includes Lupranate® 274 which is a 200 cP viscosity polymeric MDI blend product, with approximately 53 wt % PMDI, 41 wt % 4,4′-MDI, and 6 wt% 2,4′-MDI. Lupranate® 274 typically includes an amount of iron contaminant of up to 3 ppm. Composition 10 also includes about 200 ppm of 2,4-pentanedione (AcAc).

Composition 11 includes Lupranate® 274 and about 0.5 wt % of 2,4-pentanedione (AcAc).

Composition 12 includes Lupranate® 274 and about 1.0 wt % of 2,4-pentanedione (AcAc).

Composition 13 includes Lupranate® 274, about 6 ppm of iron 2-ethylhexanoate (for a total of from 6-9 ppm of iron), and about 200 ppm of 2,4-pentanedione (AcAc).

Composition 14 includes Lupranate® 274, about 6 ppm of iron 2-ethylhexanoate (for a total of from 6-9 ppm of iron), and about 0.5 wt % of 2,4-pentanedione (AcAc).

Composition 15 includes Lupranate® 274, about 6 ppm of iron 2-ethylhexanoate (for a total of from 6-9 ppm of iron), and about 1.0 wt % of 2,4-pentanedione (AcAc).

### Formation of Comparative Compositions 11-18:

Comparative Composition 11 includes Lupranate® 274 without any additives.

Comparative Composition 12 includes Lupranate® 274 and about 6 ppm of iron 2-ethylhexanoate (for a total of from 6-9 ppm of iron).

Comparative Composition 13 includes Lupranate® 274 and about 0.05 wt % of an acid chloride generator.

Comparative Composition 14 includes Lupranate® 274 and about 0.1 wt % of a phosphoric acid ester.

Comparative Composition 15 includes Lupranate® 274 and about 0.5 wt % of a phosphoric acid ester.

Comparative Composition 16 includes Lupranate® 274, about 6 ppm of iron 2-ethylhexanoate (for a total of from 6-9 ppm of iron), and about 0.05 wt % of an acid chloride generator.

Comparative Composition 17 includes Lupranate® 274, about 6 ppm of iron 2-ethylhexanoate (for a total of from 6-9 ppm of iron), and about 0.1 wt % of a phosphoric acid ester.

Comparative Composition 18 includes Lupranate® 274, about 6 ppm of iron 2-ethylhexanoate (for a total of from 6-9 ppm of iron), and about 0.5 wt % of a phosphoric acid ester.

The Second Polyol Resin includes 92 wt % of a TMP initiated PO triol having an OH number of about 500, 8 wt % of an ethylene diamine initiated tetrol having an OH number of about 480, and 5 wt % of molecular sieve powder, type 4A.

### Formation and Evaluation of Polyurethanes 10-15 and Comparative Polyurethanes 11-18:

After formation, each of the Compositions 10-15, the Comparative Compositions 11-18, and the second Polyol Resin are heated to 25° C. Subsequently, 140 g of each of the Compositions 10-15 and the Comparative Compositions 11-18 are independently combined with 100 g of the second Polyol Resin to form mixtures which are stirred for 30 seconds using a motorized mixer. After 30 seconds of stirring, each of the mixtures is placed into separate foam block insulators. Subsequently, a thermocouple is placed into the center of each of the mixtures and the mixtures are covered and allowed to react to form the Polyurethanes 10-15 and the Comparative Polyurethanes 11-18, respectively. The thermocouples measure the exotherm temperatures of the Polyurethanes 10-15 and the Comparative Polyurethanes 11-18. The time taken for the exotherm temperatures of the Polyurethanes 10-15 and the Comparative Polyurethanes 11-18 to reach 90° C. is measured and set forth below in Table 3. Generally, the shorter the time needed to reach 90° C., the more reactive the isocyanate composition.

TABLE 3

| | | | | | | | Comp. |
|---|---|---|---|---|---|---|---|
| | | | | | | | PU |
| | PU 10 | PU 11 | PU 12 | PU 13 | PU 14 | PU 15 | 11 |
| Time (sec) | 1289 | 1393 | 1339 | 1097 | 1332 | 1383 | 926 |
| for Exotherm Temperature | | | | | | | |
| to Reach 90° C. | | | | | | | |
| | Comp. | Comp. | Comp. | Comp. | Comp. | Comp. | Comp. |
| | PU | PU | PU | PU | PU | PU | PU |
| | 12 | 13 | 14 | 15 | 16 | 17 | 18 |
| Time (sec) | 516 | 935 | 904 | 884 | 539 | 623 | 765 |
| for Exotherm Temperature | | | | | | | |
| to Reach 90° C. | | | | | | | |

The data set forth in Tables 3 suggests that the addition of the 2,4-pentanedione increases the time taken for the Polyurethanes 10-15 to reach an exotherm temperature of 90° C. as compared to most of the Comparative Polyurethanes. Said differently, the data suggests that the 2,4-pentanedione decreases the reactivity of the isocyanate compositions by minimizing the catalytic effect of the iron contaminant.

Acid generators and phosphoric acid esters, such as those described above, are typically added to polyurethane compositions to slow down polyurethane forming reactions, i.e., increase the time taken for polyurethanes to reach certain exotherm temperatures. In general, this is shown in the Examples above. However, the effects from the acid generator and phosphoric acid ester in the Examples are not nearly as large as the effect (i.e., the increase in time) exhibited upon inclusion of the 2,4-pentanedione in the Polyurethanes 10-15. This difference in time evidences the special and unexpected results achieved by the instant invention.

Of particular note, the inclusion of 0.02 wt % of 2,4-pentanedione in Polyurethane 13 slows the time taken to reach 90° C. to 1097 seconds, i.e., by approximately 112% when compared to the 516 seconds taken for the control Comparative Polyurethane 12. This increase is time is much larger than the increase observed upon use of 0.05 wt % of the acid chloride generator (4% slower) in Comparative Polyurethane 16 or upon the use of ten times as much phosphoric acid ester (48% slower) in Comparative Polyurethane 18. Accordingly, this data suggests that the 2,4-pentanedione is effective in minimizing the catalytic efficiency of the iron and is at the same time unexpectedly more effective than the acid generators. Hence, use of the 2,4-pentanedione stabilizes the reactivity profiles of the isocyanate compositions and allows the isocyanate compositions to be used in a variety of specialized applications thus maximizing the overall market for PMDI, decreasing costs associated with purification and removal of the iron contaminant, and decreasing waste associated with the disposal of undesirable isocyanates.

### Formation and Evaluation of Additional Compositions/Polyurethanes:

Compositions 16 and 17 and Comparative Compositions 19 and 20 are formed and reacted with a third Polyol Resin to form Polyurethanes 16 and 17 and Comparative Polyurethanes 19 and 20, respectively. A temperature of a reaction mixture of the Compositions and the third Polyol Resin time is measured 30 minutes after the Compositions and the third Polyol Resin are combined. Typically, a temperature of less than 54.4° C. indicates that the Composition is suitable for use in applications such as foam in a can products. Notably, the Comparative Compositions 19 and 20, and corresponding Polyurethanes, do not include any 2,4-pentanedione (AcAc).

### Formation of Compositions 16 and 17:

Composition 16 includes Lupranate® 274, as described above, and also includes about 200 ppm of 2,4-pentanedione (AcAc).

Composition 17 includes Lupranate® 274, about 6 ppm of iron 2-ethylhexanoate (for a total of from 6-9 ppm of iron), and also includes about 200 ppm of 2,4-pentanedione (AcAc).

### Formation of Comparative Compositions 19 and 20:

Comparative Composition 19 includes Lupranate® 274 without any additives.

Comparative Composition 20 includes Lupranate® 274 and about 6 ppm of iron 2-ethylhexanoate (for a total of from 6-9 ppm of iron).

### Formation and Evaluation of Polyurethanes 16-17 and Comparative Polyurethanes 19-20:

After formation, each of the Compositions 16 and 17, the Comparative Compositions 11-18, and the third Polyol Resin are heated to 25° C. The third Polyol resin is the same as the first Polyol Resin and includes 68% Pluracol® 1203 polyol, 30% flame retardant, 1% surfactant, and 1.8% catalyst.

Subsequently, 311g of each of the Compositions 16 and 17 and the Comparative Compositions 19 and 20 are independently combined with 223 g of the third Polyol Resin to form mixtures which are stirred for 30 seconds using a motorized mixer. After 30 seconds of stirring, each of the mixtures is placed into separate foam block insulators. Subsequently, a thermocouple is placed into the center of each of the mixtures and the mixtures are covered and allowed to react to form the Polyurethanes 16 and 17 and the Comparative Polyurethanes 19 and 20, respectively. After 30 minutes, the thermocouples measure the exotherm temperatures of the Polyurethanes 16 and 17 and the Comparative Polyurethanes 19 and 20. These temperatures are set forth below in Table 4.

TABLE 4

| | | | Comp. | Comp. |
|---|---|---|---|---|
| | PU 16 | PU 17 | PU 19 | PU 20 |
| Temperature (° C.) | 33.9 | 36 | 46.8 | 67.3 |
| After 30 Minutes | | | | |

The data set forth in Table 4 is similar to the data set forth in Table 3 above and demonstrates that the addition of the 2,4-pentanedione decreases the speed of the reaction of the isocyanate and the polyol, as exhibited by exotherm temperatures. Said differently, the data suggests that the 2,4-pentanedione decreases the reactivity of the isocyanate compositions by minimizing the catalytic effect of the iron contaminant.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A method of minimizing a catalytic effect of an iron contaminant present in an isocyanate composition that is reacted with a polyol to form a polyurethane, said method comprising the steps of:
A. providing the isocyanate composition comprising polymeric methylene diphenyl diisocyanate and the iron contaminant; and
B. combining a beta-dicarbonyl and the isocyanate composition to associate the beta-dicarbonyl with the iron contaminant.

2. A method as set forth in claim 1 wherein the iron contaminant is present in an amount of up to 20 parts by weight per one million parts by weight of the isocyanate composition and wherein the beta-dicarbonyl is combined with the isocyanate composition in an amount of at least 100 parts by weight per one million parts by weight of the isocyanate composition.

3. A method as set forth in claim 1 wherein at least a portion of the iron contaminant is further defined as an iron (III) oxide.

4. A method as set forth in claim 3 wherein the step of combining the beta-dicarbonyl and the isocyanate composition results in the isocyanate composition having less than 3 parts by weight of non-associated iron (III) oxide per one million parts by weight of the isocyanate composition.

5. A method as set forth in claim 4 wherein the beta-dicarbonyl is further defined as 2,4-pentanedione.

6. A method as set forth in claim 1 wherein the beta-dicarbonyl is further defined as 2,4-pentanedione.

7. A method as set forth in claim 1 wherein the isocyanate composition further comprises monomeric methylene diphenyl diisocyanate in an amount of from 25 to 90 parts by weight per 100 parts by weight of the isocyanate composition and the beta-dicarbonyl is further defined as 2,4-pentanedione.

8. A method as set forth in claim 1 wherein the isocyanate composition further comprises monomeric methylene diphenyl diisocyanate in an amount of from 25 to 50 parts by weight per 100 parts by weight of the isocyanate composition and the beta-dicarbonyl is further defined as 2,4-pentanedione.

9. A method as set forth in claim 1 wherein the isocyanate composition further comprises monomeric methylene diphenyl diisocyanate in an amount of from 55 to 60 parts by weight of the isocyanate composition and the beta-dicarbonyl is further defined as 2,4-pentanedione.

10. A method as set forth in claim 1 wherein the isocyanate composition further comprises monomeric methylene diphenyl diisocyanate in an amount of from 65 to 70 parts by weight of the isocyanate composition and the beta-dicarbonyl is further defined as 2,4-pentanedione.

11. A method as set forth in claim 1 wherein the isocyanate composition further comprises monomeric methylene diphenyl diisocyanate in an amount of from 75 to 80 parts by weight of the isocyanate composition and the beta-dicarbonyl is further defined as 2,4-pentanedione.

12. A method as set forth in claim 1 further comprising the step of forming the polymeric methylene diphenyl diisocyanate in a reactor such that the polymeric methylene diphenyl diisocyanate includes the iron contaminant.

13. A method as set forth in claim 1 further comprising the step of reacting the isocyanate composition and the polyol to form the polyurethane after the step of combining the beta-dicarbonyl and the isocyanate composition.

14. A method as set forth in claim 13 wherein said step of reacting produces an exotherm temperature of less than about 45° C. when measured 30 minutes after said step of reacting commences.

15. A method as set forth in claim 13 wherein said step of reacting produces an exotherm temperature of less than about 90° C. when measured about 20 minutes after said step of reacting commences.

16. A method as set forth in claim 1 wherein the isocyanate composition is free of beta-ketoesters.

17. An isocyanate composition comprising a polymeric methylene diphenyl diisocyanate, a beta-dicarbonyl, and an iron contaminant.

18. An isocyanate composition as set forth in claim 17 wherein said iron contaminant is present in an amount of up to 20 parts by weight per one million parts by weight of said polymeric methylene diphenyl diisocyanate and wherein said beta-dicarbonyl is present in an amount of from 100 to 200 parts by weight per one million parts by weight of said polymeric methylene diphenyl diisocyanate.

19. An isocyanate composition as set forth in claim 17 wherein at least a portion of said iron contaminant is further defined as an iron (III) oxide.

20. An isocyanate composition as set forth in claim 17 wherein said beta-dicarbonyl is further defined as 2,4-pentanedione.

21. An isocyanate composition as set forth in claim 17 further comprising monomeric methylene diphenyl diisocyanate in an amount of from 25 to 90 parts by weight per 100 parts by weight of said isocyanate composition and wherein said beta-dicarbonyl is further defined as 2,4-pentanedione.

22. An isocyanate composition as set forth in claim 17 further comprising monomeric methylene diphenyl diisocyanate in an amount of from 25 to 50 parts by weight per 100 parts by weight of said isocyanate composition and wherein said beta-dicarbonyl is further defined as 2,4-pentanedione.

23. An isocyanate composition as set forth in claim 17 further comprising monomeric methylene diphenyl diisocyanate in an amount of from 55 to 60 parts by weight per 100 parts by weight of said isocyanate composition and wherein said beta-dicarbonyl is further defined as 2,4-pentanedione.

24. An isocyanate composition as set forth in claim 17 further comprising monomeric methylene diphenyl diisocyanate in an amount of from 65 to 70 parts by weight per 100 parts by weight of said isocyanate composition and wherein said beta-dicarbonyl is further defined as 2,4-pentanedione.

25. An isocyanate composition as set forth in claim 17 further comprising monomeric methylene diphenyl diisocyanate in an amount of from 75 to 80 parts by weight per 100 parts by weight of said isocyanate composition and wherein said beta-dicarbonyl is further defined as 2,4-pentanedione.

26. An isocyanate composition as set forth in claim 17 that is free of beta-ketoesters.

27. A polyurethane system comprising a polyol and said isocyanate composition set forth in claim 17.

28. A polyurethane formed from said polyurethane system as set forth in claim 27 and exhibiting an exotherm temperature of less than about 45° C. measured 30 minutes after said isocyanate composition and said polyol begin to react.

29. A polyurethane formed from said polyurethane system as set forth in claim 27 and exhibiting a temperature of less than about 90° C. measured 20 minutes after said isocyanate composition and said polyol begin to react.

30. A method of minimizing a catalytic effect of an iron contaminant present in an isocyanate composition that is reacted with a polyol to form a polyurethane, said method comprising the steps of:
A. providing the isocyanate composition comprising;
(1) the iron contaminant present in an amount of up to 20 parts by weight per one million parts by weight of the isocyanate composition,
(2) at least 50 parts by weight of polymeric methylene diphenyl diisocyanate per 100 parts by weight of the isocyanate composition, and
(3) monomeric methylene diphenyl diisocyanate; and
B. combining the isocyanate composition and at least 125 parts by weight of 2,4-pentanedione per one million parts by weight of the isocyanate composition to associate the 2,4-pentanedione with the iron contaminant.

31. A method as set forth in claim 30 wherein the iron contaminant is further defined as iron oxide.
